(19) United States
(12) Patent Application Publication
(10) Pub. No.: US 2012/0327203 A1
(43) Pub. Date: Dec. 27, 2012

(54) APPARATUS AND METHOD FOR PROVIDING GUIDING SERVICE IN PORTABLE TERMINAL

(75) Inventors: Sang-Hoon OH, Gyeonggi-do (KR); In-Yong CHOI, Gyeonggi-do (KR); Kyoung-Ho BANG, Seoul (KR)

(73) Assignee: SAMSUNG ELECTRONICS CO., LTD., Gyeonggi-Do (KR)

(21) Appl. No.: 13/466,667

(22) Filed: May 8, 2012

(30) Foreign Application Priority Data
Jun. 21, 2011 (KR) 10-2011-0060245

(51) Int. Cl. G06K 9/46; H04N 7/18

(52) U.S. Cl. 348/62; 382/103; 348/E07.085

(57) ABSTRACT

The present invention provides an apparatus and a method for a complementary walking service by a portable terminal. The method for providing the complementary walking service preferably includes obtaining an image of a walker's route, extracting at least one preliminary risk factor component from the image, checking risk factor data depending on a portable terminal and detecting risk factors existing in the walker's route by matching the preliminary factor risk factor component to the risk factor data.

### CLAIM OF PRIORITY

The present application claims the benefit from a Korean patent application filed in the Korean Intellectual Property Office on Jun. 21, 2011, and assigned Serial No. 10-2011-0060245, the entire disclosure of which is hereby incorporated by reference in its entirety.

### BACKGROUND OF THE INVENTION

1. Field of the Invention

The present invention relates to an apparatus and a method for providing directions to a user in motion. More particularly, the present invention relates to a guiding service in a portable terminal for persons with disabilities.

2. Description of the Related Art

A blind or otherwise visually-impaired person may have difficulty in walking from place to place because he or she cannot obtain information about the environment while in motion, In addition, such a person can be at a significant risk factor of injury or death for an inability to be compensated for obstacles in one's path. In the past, such visually-impaired persons were given aids such as a stick, a guide dog and a guiding person when he walks. Each of these items has advantages and disadvantages, for example, as a stick cannot determine what is in front one while walking, just that something is there. Guide dog or human guide both have their limitations in terms of personal travel.

As described in more detail, when the visually impaired person utilizes aids such as a stick, a guide dog and/or a guiding person, such a person can reduce a risk factor of injury or misstep only within the distance corresponding to the length of the stick and has the disadvantage in that he is accompanied by the guide dog or the guiding person on every single occasion that he goes out.

Meanwhile, a portable terminal has become a necessity for modern life due to the ease of portability, ease of use, increased functionality, extended battery life, and overall costs. Portable terminal are already being used by the visually impaired to provide various services.

Therefore, there is a long-felt need in the art for a method and apparatus that provides a guiding service via a portable terminal to the visually-impaired users of portable terminals.

### SUMMARY OF THE INVENTION

To address at least some of the above-discussed deficiencies and provide at least some of the following advantages, it is an exemplary aspect of the present invention is to provide an apparatus and a method for offering a guiding service in a portable terminal.

Another exemplary aspect of the presently claimed invention is to provide an apparatus and a method for offering a guiding service to a blind person via a portable terminal.

Yet another exemplary aspect of the presently claimed invention is to provide an apparatus and a method for a portable terminal that operates a guiding service to a blind person utilizing a camera of a portable terminal.

Still another exemplary aspect of the present invention is to provide an apparatus and a method for a portable terminal to provide a guiding service with adaptability depending on positional information of a blind person in a portable terminal.

According to an exemplary aspect of the present invention of the present invention in which a method for providing a guiding service in a portable terminal preferably includes obtaining an image of a walking route of a walker, extracting at least one preliminary risk factor component from the image, checking risk factor data depending on the position of a portable terminal and detecting risk factors on the route of the walker by matching the preliminary risk factor component to the risk factor data.

According to another exemplary aspect of the present invention to achieve the purposes of the present invention, an apparatus for providing a guiding service in a portable terminal preferably includes a camera module for obtaining an image of a waling route of a walker, a position determiner for verifying the position of the portable terminal and a controller for extracting at least one preliminary risk factor in the image obtained from the camera module and detecting a risk factor on the walking route of the walker by matching the at least one preliminary risk factor component to risk factor data depending on the position of the portable terminal.

### BRIEF DESCRIPTION OF THE DRAWINGS

The above and other exemplary aspects, features and advantages of certain exemplary embodiments of the present invention will be more apparent from the following detailed description taken in conjunction with the accompanying drawings, in which:

FIG. 1 is an exemplary block configuration of a portable terminal according to the present invention.

FIG. 2 is a detailed exemplary block configuration of a controller of a portable terminal according to the present invention.

FIG. 3 is a flowchart illustrating an exemplary operational process for providing a guiding service in a portable terminal according to an exemplary embodiment of the present invention.

FIG. 4 is a flowchart illustrating a process for providing guiding a service in a portable according to another exemplary embodiment of the present invention.

FIG. 5 is a flowchart illustrating a process for providing a guiding service in a portable terminal according to another exemplary embodiment of the present invention.

FIG. 6 is a flowchart illustrating a process for generating ROI (Region of Interest) in a portable terminal according to an exemplary embodiment of the present invention.

FIG. 7 is a flowchart illustrating a process for generating ROI in a portable terminal according to another exemplary embodiment of the present invention.

FIG. 8 is a flowchart illustrating a process for generating ROI in a portable terminal according to another exemplary embodiment of the present invention.

FIG. 9 is a configuration for determining classifying information in a portable according to an exemplary embodiment of the present invention.

### DETAILED DESCRIPTION

The following description with reference to the accompanying drawings is provided to assist a person of ordinary skill in the art with a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the exemplary embodiments described herein can be made without departing from the scope and spirit of the presently claimed invention. In addition, descriptions of well-known functions and constructions may be omitted for clarity and conciseness when their inclusion may obscure appreciation of the present invention by a person of ordinary skill in the art.

The terms and words used in the following description and claims are not limited to the bibliographical meanings, but are to be interpreted as a person of ordinary skill in the art would understand them to mean in view of the specification, as opposed to a mere dictionary definition. The description is provided to enable a person of ordinary skill in the art to have a clear and consistent understanding of the invention so as to be able to practice the claimed invention without undue experimentation. Accordingly, those skilled in the art should appreciate that the following description of exemplary embodiments of the present invention is provided for illustrative purposes only and not for the purpose of limiting the scope of the claimed invention as defined by the appended claims and their equivalents.

It is to be further understood that the singular forms “a,” “an,” and “the” include plural referents unless the context clearly dictates otherwise. Thus, for example, reference to “a component surface” includes reference to one or more of such surfaces. In addition, the term “substantially” as used herein means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary technology that can be used for providing a guiding service in a portable terminal according to the present invention will now be described as follows.

A portable terminal may comprise, for example, a laptop, a smart phone, a net book, a mobile internet device, an ultra mobile PC, a tablet personal computer, a mobile telecommunication terminal, PDA having a camera and the like herein, just to name some of the possibilities.

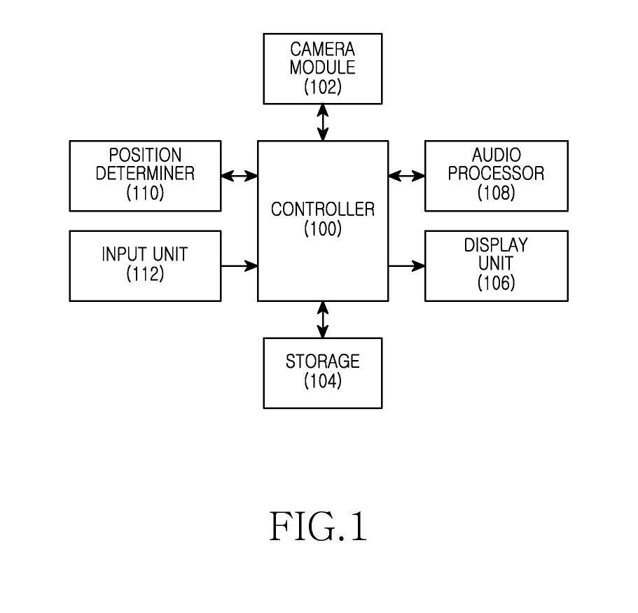

FIG. 1 is an exemplary block configuration of a portable terminal according to the present invention.

As shown in FIG. 1, a portable terminal preferably comprises a controller 100, a camera module 102, a storage unit 104, a display unit 106, an audio processor 108, a position determiner110 and an input unit 112.

The controller 100, which includes a processor or microprocessor, preferably executes the control of the overall operation of the portable terminal, and can be configured to function, for example, as shown in the flowcharts shown and described herein.

The controller 100 is able to detect a risk factor occurring when a blind person walks about through using/analyzing image data output by the camera module 102.

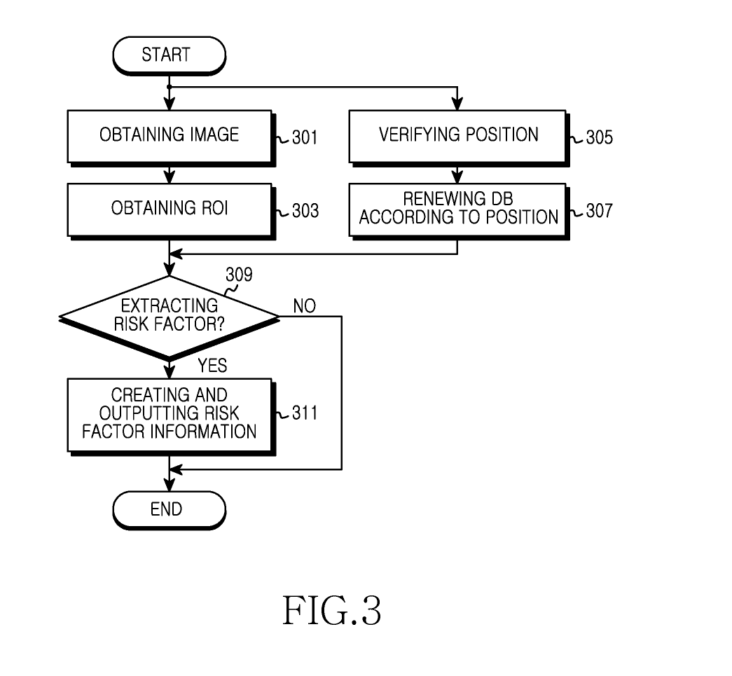

For example, the controller 100 can operate according to the flowchart shown in FIG. 3, detecting the risk factor using the image data offered from the camera module 102.

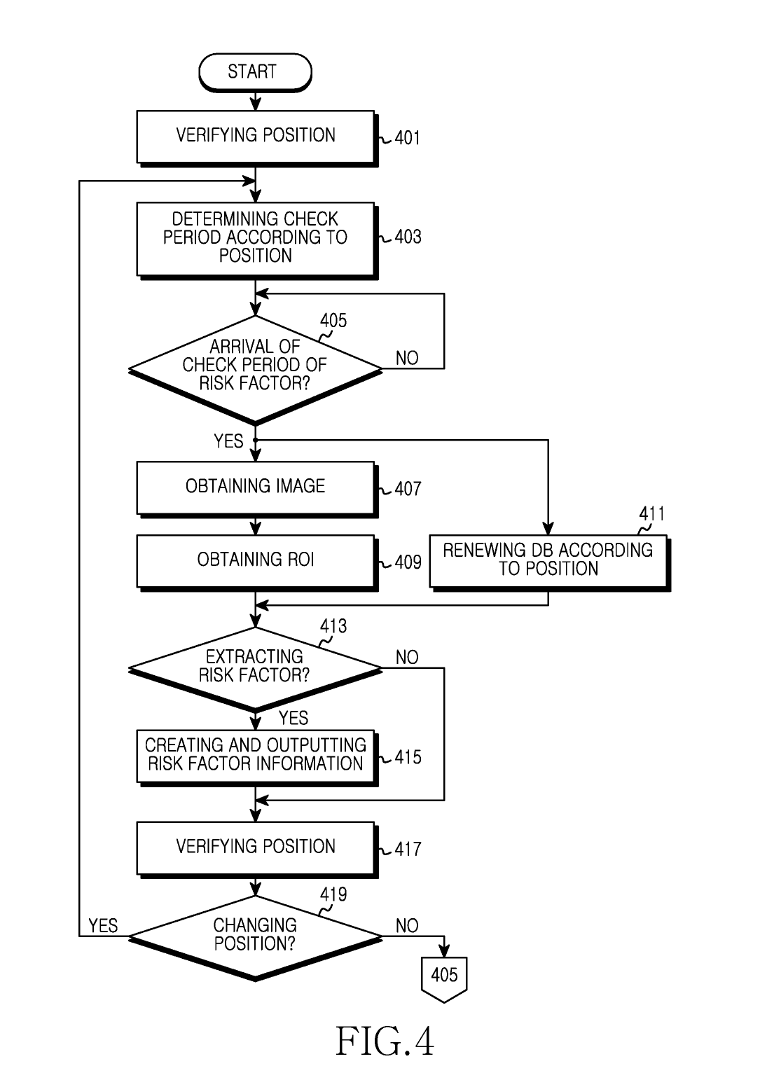

In another example, the controller 100 determines a verification period of the risk factor considering the positional information offered from the position determiner 110, as shown in FIG. 4. For another example, the controller 100 can detect a risk factor using the image data and the positional information of the portable terminal depending on the “check” period of the risk factor. In this case, the controller 100 may renew or extend the check period of the risk factor considering the positional information of the portable terminal.

The controller 100 can be configured to generate a warning event in response to recognizing a risk factor when such risk factor is detected.

The camera module 102 converts the image data of a subject into digital data and can output stationary or moving images obtained from the digital data to the controller 100.

The storage unit 104, which comprises a machine readable non-transitory medium for storing data, can be logically or physically subdivided to include, for example, a program storage unit for storing a program to control the operation of the portable terminal and a data storage unit for storing the data made during the operation of the program execution. For example, the storage unit 104 may store a risk factor data that is required or desirable in order to recognize or enhance recognition of a risk factor in the controller 100.

For example, the storage unit 104 may store risk factor data that can be used for detecting some or all of the risk factor data in the portable terminal, for example a history of risk factors regarding locations the portable terminal has been transported to, or can store risk factor data only regarding an area where the portable terminal is currently located. Moreover, it is within the spirit and scope of the claimed invention that a pre-programmed map of risk data can be provided to the portable terminal that can be accessed regarding possible risk in any given path of travel selected by a user of the present invention. When the risk factor data in the area of the portable terminal only is stored in the portable terminal, the risk factor data stored in the storage unit 104 may be updated, renewed, and classified as risk factor data of a corresponding area by being offered by a separate server or base station according the control of the controller 100. It is also possible that this risk data can be shared among devices on a peer-to-peer basis.

The method described hereunder of the present invention may be provided as one or more instructions in one or more software modules stored in the storage unit 104. The software modules may be executed by the controller 100.

The display unit 106 may preferably display the status information of the portable terminal, characters input by a user, a moving picture, a still picture and the like according to control of the controller 100. For example, the display unit 106 may be constructed as a touch screen executing the function of information display and input means all together. In this case, the display unit 106 may provide the controller 100 with the information of user's touch.

The audio processor 108 may control the input and output of audio signal. For example, the audio processor 108 can output a warning message regarding a risk factor detected by the controller 100. In a non-limiting example of a risk factor, if the controller determines an obstruction in the walking path of a user has been captured by the camera, such an obstruction can be considered to be a risk factor.

With continued reference to FIG. 1, the position determiner 110 may determine the position of the portable terminal. For example, the position determiner 110 can determine or within a predetermined error range an approximate the location of the portable terminal using at least one method from among, for example, a GPS method, a triangulation method and a beacon message method known as the methods of the position recognition.

The input unit 112 may provide the controller 100 with the input data made by selection of a user. For example, the input unit 112 may comprise a real or virtual key pad with which the user inputs data. In another example, if the display unit 106 comprises a touch screen, the input unit 112 may have only controlling buttons for controlling a device with the touch screen, or there can be one physical device for the two operations (display, information input).

In fact, it is within the spirit and scope of the presently claimed invention that the input unit 112 and display unit 106 could all be served by a single touch screen. That is, a touch sensitive display, called as a touch screen, may be used as the display unit 106. In this situation, touch input may be performed via the touch sensitive display.

Although not shown in FIG. 1, the portable terminal may further comprise a communication unit to process communications signals that are transmitted and received through wireless resource. One or more types of wireless protocols can be present, such as in current state of the art portable communication devices. According to the present invention, for example, an electronic device comprising one or more controller, a touch screen, a storage unit and one or software modules stored in the memory configured for execution by the controller, the software modules comprising one or more instruction to perform methods described hereunder.

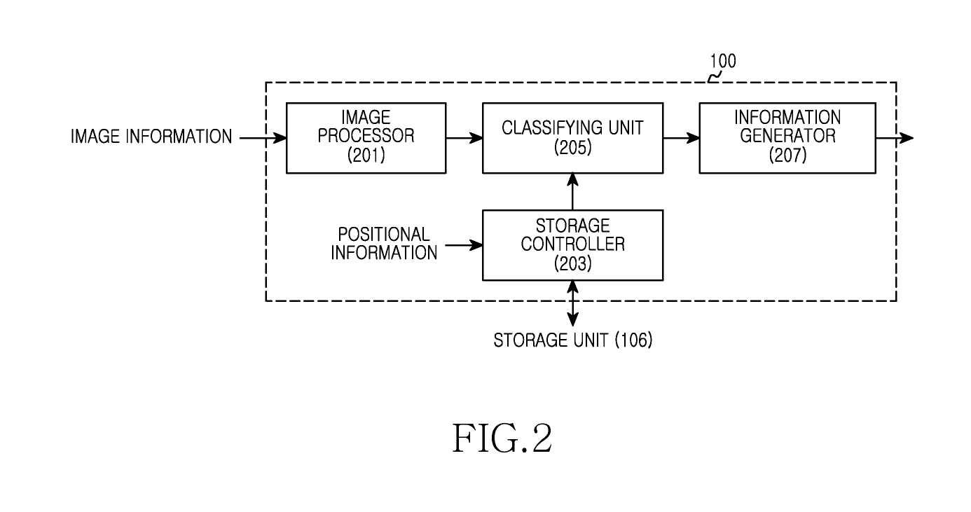

FIG. 2 is a detailed exemplary block configuration of a controller of a portable terminal according to the present invention.

As shown in FIG. 2, the controller 100 may comprise an image processor 201, a storage controller 203, a classifying unit 205 and an information generator 207. The artisan understands and appreciates that the operation of one or more of the aforementioned items shown in FIG. 2 can be combined into fewer or more units, as the actual physical controller may be constructed different than a logical arrangement for explanatory purposes. For example, the image processor 201 may determine at least one Region of Interest (ROI) using image data of a frame unit offered from the camera module 102.

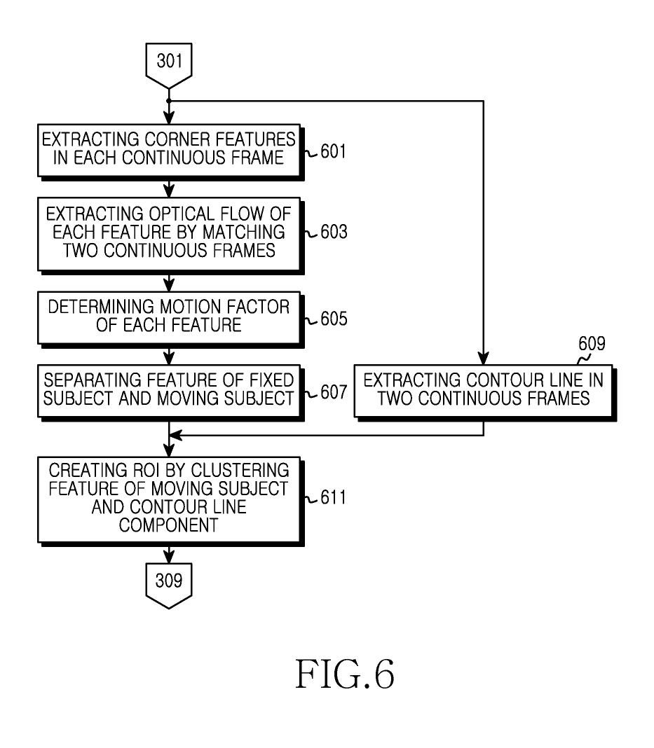

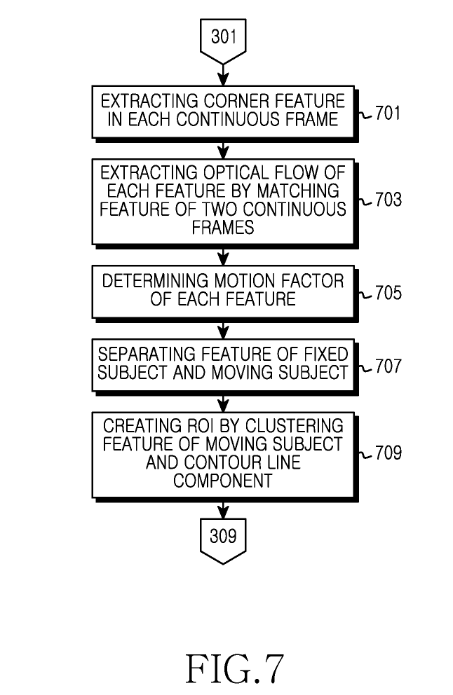

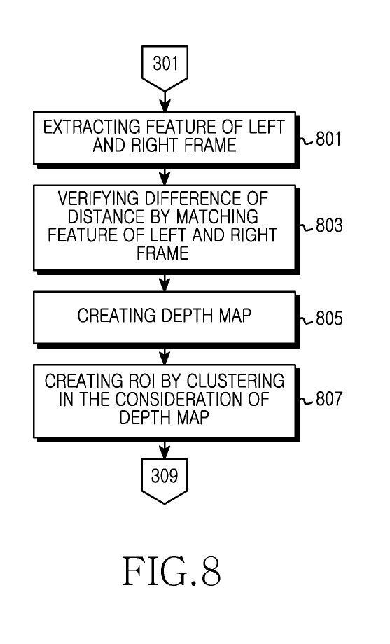

For example, if the camera module 102 comprises only one camera, the image processor 201 may determine at least one ROI for detecting a risk factor as shown in FIG. 6 or FIG. 7. In another example, if the camera module 102 comprises at least two cameras, the image processor 201 may determine at least one ROI for detecting a risk factor as shown in FIG. 8.

The storage controller 203 may extract risk factor data corresponding to the positional information of the portable terminal from among the risk factor data stored in the storage unit 104 and provide to the classifying unit 205.

The classifying unit 205 may extract a risk factor corresponding to ROI determined in the image processor 201 from the risk factor data provided the storage unit 104 with.

The information generator 207 in this example creates a message to generate a warning event regarding the risk factor verified in the classifying unit 205. For example, the information generator 207 can create a warning message that is played back by the audio processor 108.

In the exemplary embodiment above-mentioned in detail, the store controller 203 may extract risk factor data corresponding to the positional information of the portable terminal among the risk factor data stored in the storage unit 104 and provide to the classifying unit 205. But when the risk factor data of the area where the portable terminal is located are not stored in the storage unit 104, the store controller 203 may store risk factor data of the corresponding area offered from a separated server and provide to the classifying unit 205 with the corresponding risk factor data.

A method for providing a guiding service in a portable terminal according to an exemplary embodiment of the present invention will be described in conjunction with at least FIG. 3.

FIG. 3 is a flowchart illustrating a process for providing a guiding service in a portable terminal according to an exemplary embodiment of the present invention.

Referring now to FIG. 3, at step 301, when a guiding service is provided in a portable terminal, the image of the walking route of a walker may be obtained through the camera module 102. For example, the image of the frame unit may be obtained from the image from the camera module 102 in the portable terminal.

Next at step 303, the ROI related to a risk factor from the image of frame unit may be extracted by the portable terminal. For example, if the camera module 102 comprises one camera, at least one ROI can be determined for detecting a risk factor in the portable terminal as shown in FIG. 6 or FIG. 7. For other example, if the camera module 102 comprises at least two cameras, at least one ROI may be determined for detecting a risk factor in the portable terminal, as shown in FIG. 8.

Additionally, when a guiding service is provided, at step 305 the position of the portable terminal may be verified. For example, the position of the portable terminal may use at least one among GPS method, triangulation method and beacon message method as the method of the position recognition.

Then, at step 307, the position factor data of the classifying unit 205 may be renewed depending on the position of the portable terminal. For example, there are in this example four possible sites where a walker can walk may be assumed as shown in the following Table 1.

TABLE 1

| | | Residential | Subway/Train | Inside | Common |
|---|---|---|---|---|---|
| Site | Road side | Area | Station | Building | Condition |
| DB | Street tree | Flower Pot | Platform | Elevator | Walker |
| Component | Vehicle | Street Tree | Elevator | Escalator | Building |
| (Obstacles) | Motorcycle | Traffic | Escalator | Door | Steps |
| | Traffic Lights | Light | Pass gate | Chair/Desk | Animals |
| | Road Sign | Motorcycle | | | |
| | Crosswalk | | | | |
| | Curb | | | | |

Therefore, the database of the classifying unit 205 may be renewed/updated in order to include the risk factor data corresponding to the positional information of the portable terminal in the portable terminal. In this case, the position factor data of the area may be provided to the portable terminal from a separate server or via a base station in communication with a server and the risk factor data of the classifying unit 205 may be renewed. Also, the risk factor data of the area where the portable terminal is located can be extracted from the risk factor data of the area stored at the store unit 104 of the portable terminal and the risk factor data of the classifying unit 205 may be renewed/updated. The items in Table 1 can be considered to be risk factor data. In contrast to risk factor data, “Preliminary risk factor component data” are items detected in the image, such as obstructions in the walker's path. Obstructions in the walker's path or serve as a potential hazard can be compared with Table 1 or a database to identify the item that is an obstruction or potential obstruction. Also, items that are unidentified but are nonetheless obstacles in the walker's path can also be considered preliminary risk factor components. Preliminary risk factor component data indicates a potential risk or a potential hazard. Comparison is made with the items listed in table 1 which is stored in storage unit 104 to determine whether any of these items are identified or match the image captures by the camera module 102. The image from the camera module 102 is analyzed in a known method to be compared with the items in table 1. The analysis methods are not described in detail but one skilled in the art can use the methods from the known technologies. The items in table 1 and the image from the camera may be judged as the same risk or hazard if feature points are matched between items in table 1 and the image from the camera. The feature points may be predetermined in image of the items in table 1. The feature points for image from the camera may be automatically determined according to the size of the image. The matching of feature points is known method and is not described in detail but one skilled in the art can use the methods from the known technologies.

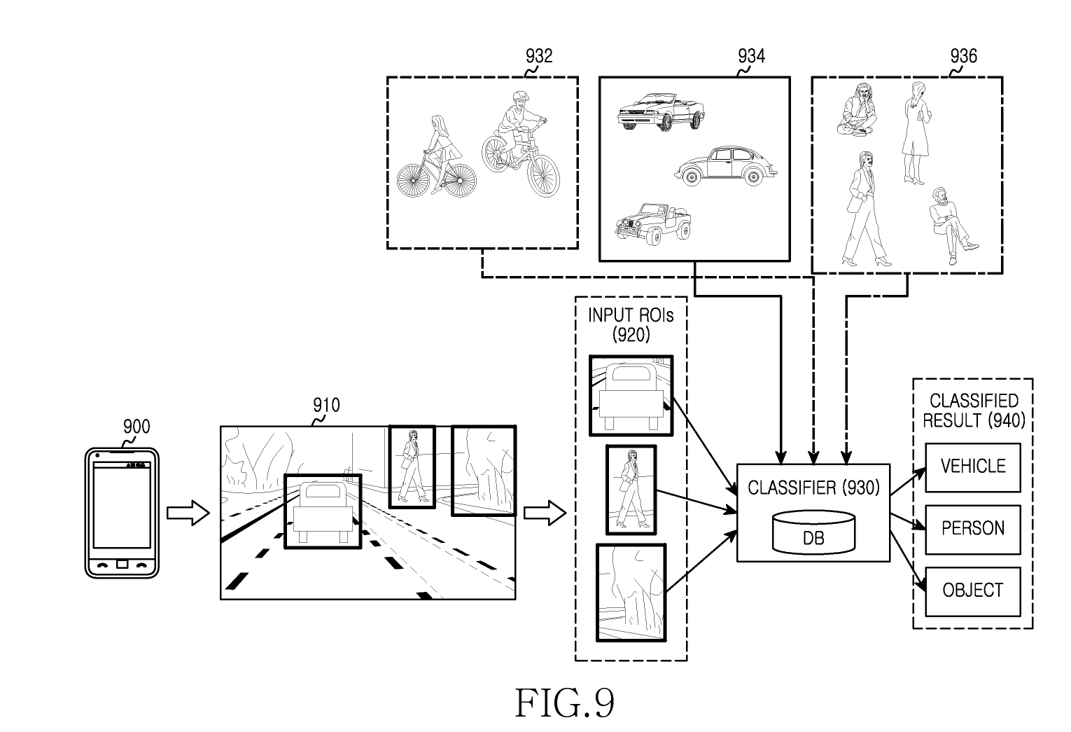

With continued reference to the flowchart in FIG. 3, at step 309, the ROI determined in step 303 may be matched with the renewed risk factor data of step 307 and a risk factor such as obstacles in the route of the walker may be verified. For example, ROI 920 for verifying the risk factor in the frame image 910 may be extracted in the portable terminal as shown in FIG. 9. In addition, with reference to FIG. 9, the risk factor data 932, 934 and 935 according to the positional information of the portable terminal may be renewed in the portable terminal. In this particular example, the image 940 matched to ROI 920 in the risk factor data 932, 934, 936 may be recognized as a risk factor that the walker using the portable terminal would be made aware of (i.e. notified). In the meanwhile, if there is no image matched to the ROI 920 in the risk factor data 932, 934 and 936, then it can be recognized that there is no risk factor in the portable terminal.

Therefore, when at step 309 there is no risk factor in the route of the walker, the algorithm may be terminated in the portable terminal. In this case, the image of the walking route may be obtained again by returning to step 301 in the portable terminal.

Referring now to FIG. 3 again, at step 311, if there is a risk factor in the route of the walker, a warning event against the corresponding risk factor may be generated. For example, a warning message that warns about the collision risk in view of the corresponding risk factor, the distance to the risk factor, the expected collision time, the direction toward the corresponding risk factor and the like may be generated in the portable terminal. Moreover, the message may be output to the walker through the audio processor 108 of the portable terminal.

Finally, after step 311, the algorithm may be terminated in the portable terminal In this case, the image of the route of the walker may be obtained again in the portable terminal by returning to step 301.

The method performed according to FIG. 3 may be provided as one or more instructions in one or more software modules stored in the storage unit. In that case, the software modules may be executed by the controller 100.

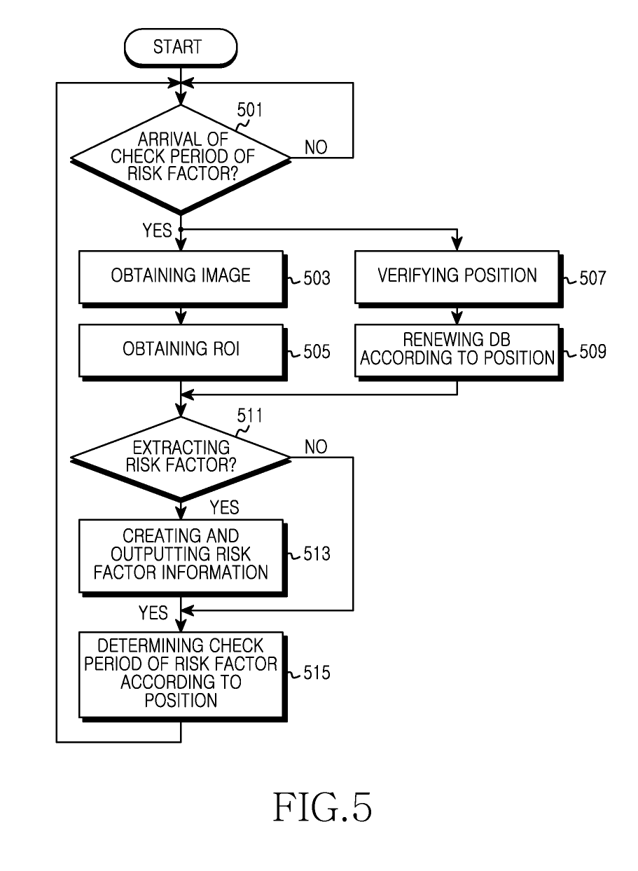

In the above-mentioned exemplary embodiments, the risk factor in the route of the walker may be recognized using the risk factor data corresponding to the position of the portable terminal in the portable terminal. In this case, the period for checking the existence of the risk factor on the route of the walker may be regulated, as shown in FIG. 4 or FIG. 5.

FIG. 4 is a flowchart illustrating exemplary operation of a process for providing a guiding service in a portable according to other exemplary embodiment of the present invention.

Referring now to FIG. 4, at step 401, when a guiding service is provided in the portable terminal, the position of the portable terminal may be verified in the portable terminal. For example, the position of the portable terminal may be determined using at least one method from among, for example, a GPS method, triangulation method and beacon message method.

Next, as step 403, a check period of the risk factor may be determined considering the positional information of the portable terminal in the portable terminal. For example, the degree of risk may be estimated in the portable terminal by considering the positional information of the portable terminal when walking along the route. Subsequently, the check period of the risk factor, which depends on the estimated degree of the risk, may be determined in the portable terminal at 5403. The higher the degree of the risk factor as walking along the route in the portable terminal is, the shorter the check period of the risk factor may be determined.

After determining at step 403 that the check period of the risk factor is determined, it may then be verified in the portable terminal at step 405 whether the check time arrives.

If at step 405 the time for determining the check period of the risk factor arrives, then at step 407 an image related to the route of the walker may be obtained using the camera module 102 in the portable terminal. For example, the image of frame unit may be obtained using the image from the image of the camera module 102.

Then at step 409, the ROI related to the risk factor may be extracted from the image of the frame unit in the portable terminal. For example, if the camera module 102 comprises a single camera, at least one ROI may be determined for recognizing the risk factor in the portable terminal, as shown in the following FIG. 6 or in FIG. 7. In another example, if the camera module 102 comprises at least two cameras, at least one ROI for recognizing the risk factor may be determined in the portable terminal, as shown in the following FIG. 8.

In addition, if at step 405 the time for verifying the check period arrives, then at step 409 the position factor data of the classifying unit 205 may be renewed at step 411 depending on the location of the portable terminal in the portable terminal For example, when four possible sites for the route of the walker are set as shown in Table 1, the database of the classifying unit 205 may be renewed for comprising the risk factor data corresponding to the positional information of the portable terminal in the portable terminal. In this case, the position factor data of the area may be provided from a separate server and the risk factor data of the classifying unit 205 may be renewed in the portable terminal. Also, the risk factor data of the area where the portable terminal is located may be extracted and the risk factor data of the classifying unit 205 may be renewed.

With regard to step 413, the ROI determined in the step of 409 may be matched to the risk factor data renewed in the step of 411 and it is verified that a risk factor such as obstacles exists or not in the route of the walker in the portable terminal.

For example, with reference to FIG. 9, the ROI 902 may be extracted for verifying a risk factor in the frame image 910 in the portable terminal, as shown in FIG. 9. Moreover, the risk factor data 932, 934 and 936 may be renewed according to the positional information of the portable terminal. In this case, ROI 920 and the matched image among the risk factor data 932, 934 and 936 may be recognized as a risk factor that the walker is to be warned/notified about by the portable terminal. In the meanwhile, if there is no image matched to the ROI 920, it may be recognized that there is no detected risk factor in the portable terminal.

If there is no risk factor detected in the route of the walker, then at step 417 the position of the portable terminal may be verified again.

In the meanwhile, if there is a risk factor in the route of the walker, then at step 415 a warning event regarding the risk factor may be created and/or output by the portable terminal.

For example, a warning message comprising the collision risk because of the corresponding risk factor, the distance to the risk factor, the estimated time for collision and the like in the portable terminal may be created. The warning message can be output to the walker through the audio processor 108 of the portable terminal.

With continued reference to FIG. 4, at step 417, the position of the portable terminal may be verified again in the portable terminal.

After the position of the portable terminal is verified again, then at step 419, it may be verified in the portable terminal whether or not the position (i.e. location) of the portable terminal has changed (altered, etc.).

If at step 419 the position of the portable terminal is not changed, it is verified whether or not the check time for the check period of the risk factor arrives or not in the step of 405. In this case, the check period of the risk factor refers to the check period of the risk factor previously determined at step 403.

In the meanwhile, if at step 419 it is determined that the position of the portable terminal has changed, the check period of the risk factor at step 403 may be determined anew in consideration of the altered positional information of the portable terminal in the step of 403.

In the foregoing exemplary embodiment of the present invention, if the check period of the risk factor arrives in the portable terminal, the risk factor data of the classifying unit 205 may be renewed in the portable terminal depending on the position of the portable terminal.

In another exemplary embodiment of the present invention, the risk factor data of the classifying unit 205 may be renewed at any point between step of 401 verifying the position of the portable terminal and step 413 verifying whether or not the risk factor is extracted

The method performed according to FIG. 4 may be provided as one or more instructions in one or more software modules stored in the storage unit. In that case, the software modules may be executed by the controller 100.

FIG. 5 is a flowchart illustrating exemplary operation of a process for providing a guiding service in a portable terminal according to still another exemplary embodiment of the present invention.

Referring now to FIG. 5, if a guiding service is provided by the portable terminal, it is verified at step 501 whether or not the check period of the risk factor arrives. In this particular case, if the guiding service is just beginning to be carried out, it may be verified whether or not a predetermined base check period of the risk factor has arrived.

If at step 501 the check period of the risk factor arrives, then at step 503 an image related to the walker's projected route may be obtained utilizing the image output from the camera module 102 in the portable terminal.

Next, at step of 505, the ROI related to the risk factor in the image of the frame unit may be extracted. For example, if the camera module 102 comprises one camera, then at least one ROI for recognizing the risk factor may be determined in the portable terminal, as shown in FIG. 6 or FIG. 7. For other example, if camera module 102 comprises at least two cameras, at least one ROI for recognizing the risk factor in the portable terminal may be determined, as shown in the FIG. 8.

Also, when the check period of the risk factor arrives, then at step 507 the position of the portable terminal may be verified. For example, the position (i.e. location) of the portable terminal may be determined by the portable terminal using at least one method selected from among a GPS method, a triangulation method and a beacon message method.

With continued reference to FIG. 5, at step 509, the position factor data of the classifying unit 205 may be renewed depending on the location of the portable terminal. For example, as shown in TABLE 1, four sites are set for the possible routes of the walker, the database of the classifying unit 205 may be renewed for including the data of the risk factor in the portable terminal corresponding to the positional information of the portable terminal. In this case, the position factor data (position or location) of the corresponding area may be offered from a separate server and the risk factor data of the classifying unit 205 may be renewed/updated in the portable terminal And also, the risk factor data of the area where the portable terminal is located may be extracted among the risk factor data of each area stored in the storage unit 104 of the portable terminal and the risk factor data of the classifying unit 205 may be renewed.

Next, at step 511, the ROI determined from step 505 may be matched to the risk factor data renewed at step 509 and it may be verified as to whether or not a risk factor such as obstacles exists.

For example, with reference to FIG. 9, the ROI for verifying the risk factor in the frame image 910 may be extracted in the portable terminal. In addition, the risk factor data 932, 934 and 936 according to the positional information of the portable terminal may be renewed/updated in the portable terminal to reflect, for example any change in position. In this case, the image 940 matched to ROI among the risk factor data 932, 934 and 936 may be recognized as a risk factor that the walker needs to be notified of by the portable terminal. In the meanwhile, if there is no image matched to ROI 920 in the risk factor data 932, 934 and 936, it may be recognized that there is no risk factor in the portable terminal.

If at step 507 there is no risk factor in the route of the walker, a check period of the risk factor may be determined considering the positional information of the portable terminal in the portable terminal. For example, the degree of risk may be estimated or recalculated considering the positional information of the portable terminal in the portable terminal while walking along the route. In other words, in the present invention the risk can be updated in real time. After that, the check period of the risk factor depending on the estimated degree of the risk in the portable terminal may be determined. The higher the degree is of the risk factor as walking along the route indicated by the portable terminal, the shorter determination of the check period of the risk factor.

With continued reference to FIG. 5, if there is a risk factor in the route of the walker, at step 513 a warning event about the corresponding risk factor may be generated and output. For example, a warning message notifying the walker about the collision risk due to the corresponding risk factor, the distance to the risk factor, the expected collision time, the direction toward the corresponding risk factor and the like may be generated in the portable terminal. The message may be output to the walker, for example, through the audio processor 108 of the portable terminal.

Risk factor which is in motion such as a bicycle or a vehicle may be detected by sensing a air pressure or a volume of noise caused by the bicycle or the vehicle approaching the walker or the physical contact of the bicycle or the vehicle with the walker. Risk factor which is in station such as a street tree or a pass gate may be detected by sensing the physical contact of the street tree or the pass gate with the walker. Peripheral sounds may be extrapolated to determine whether the walker and an object are moving toward each other or away from other. Or peripheral sounds may be regarded as a positive correlation with risk.

In addition, at step 515 a check period of the risk factor may be determined in consideration of the positional information of the portable terminal that was verified at step of 507. For example, the degree of risk may be estimated considering the positional information of the portable terminal by the portable terminal when walking along the route. In addition, the check period of the risk factor depending on the estimated degree of the risk in the portable terminal may then be determined. The higher the degree of the risk factor as walking along the route in the portable terminal is, the shorter the check period of the risk factor may be determined.

After the check period of the risk factor is verified, the method may verify whether the check period of the risk factor determined in the step of 515 arrives back in the step of 501.

In the exemplary embodiment above-mentioned in detail, the degree of risk to a user who is walking may be estimated according to the positional information in the portable terminal.

In another exemplary embodiment, the degree of risk according to walking may be estimated by analyzing the sound transmitted from the outside in the portable terminal. For example, if the result of the analysis of the outside sound indicates that the sound of vehicles is relatively high as compared to a predetermined threshold, it may be estimated that the degree of risk according to walking along a present path is high, or at least higher than more quiet paths.

As mentioned above in detail, according to an exemplary embodiment of the present invention, the risk factor of the route undertaken by a walker may be detected in the portable terminal. In this particular case, the risk factor data of the corresponding area may be renewed/updated based on the detected risk factor in the portable terminal.

The method performed according to FIG. 5 may be provided as one or more instructions in one or more software modules stored in the storage unit. In that case, the software modules may be executed by the controller 100.

A method for obtaining ROI in the FIG. 3, FIG. 4 and FIG. 5 will now be described herein below. If the camera module 102 comprises one camera, the ROI may be extracted in the portable terminal as shown in the following FIG. 6 or FIG. 7. In the following description, it will be assumed that step 303 in FIG. 3 is materialized in the portable terminal, and that is true of FIG. 4 and FIG. 5.

FIG. 6 is a flowchart illustrating a process for generating ROI in a portable terminal according to an exemplary embodiment of the present invention.

Referring now to FIG. 6, at step 301, two continuous frame images may be obtained in the portable terminal, as indicated by the plate “301” in FIG. 6.

At step of 601, a corner feature in each frame image may be extracted in the portable terminal. After the corner feature of the continuous frame images is extracted at step 601, then at step 603 the features in the same location in the continuous frame images may be matched one-on-one and the optical flow of each feature may be obtained by the portable terminal.

Next, a motion factor related to the movement of the walker may be determined using the optical flow of each feature in the step of 605 in the portable terminal.

After the motion factor is determined, at step 607 the overall features may be separated and classified according to certain features, such as fixed subjects and moving subjects using the motion factor by the portable terminal.

Additionally, after two continuous frame images are obtained in the step of 301 (see step 301 prior to step 601 in FIG. 6) in the portable terminal, a vertical contour line component in the two continuous frame images may be extracted in the step of 609.

For example, because an obstacle has height different from that of the surface of the ground, a contour line vertical from the surface of the ground may be formed. Therefore, the vertical contour line component may be extracted from the two continuous frame images in the portable terminal. In this case, the surface of the Earth may be verified by applying an inverse (a.k.a. reverse) perspective transform matrix to the motion factor extracted in step 605 by the portable terminal.

Next, at step 611, the ROI may become a preliminary group to the risk factor and may be generated by clustering the features of the moving subject separated in step 607 and the vertical contour line component extracted in step 609.

In the foregoing exemplary embodiment described hereinabove, the motion factor related to the movement of the walker may be determined or estimated through the optical flow of each feature in the portable terminal. In this case, an error component occurring by the behavior pattern of the walker may be amended using a geometry sensor and a different component from the walking direction of the walker in the course of speculation of the motion factor may be removed in the portable terminal.

As mentioned above in detail, the ROI of the moving subject may be obtained by matching the features of the two continuous frame images and the ROI of the fixed subject may be obtained using the contour component of the two frame images in the portable terminal.

The method performed according to FIG. 6 may be provided as one or more instructions in one or more software modules stored in the storage unit. In that case, the software modules may be executed by the controller 100.

FIG. 7 is a flowchart illustrating exemplary operation of a process for generating ROI in a portable terminal according to another exemplary embodiment of the present invention.

Referring now the plate showing “301” in FIG. 7, two continuous frame images may be obtained in the portable terminal in step 301 of FIG. 3.

Next, at step 701 the corner features in each frame image may be extracted by the portable terminal.

After the corner features are extracted from each frame image, at step 703 the optical flow of each feature may be obtained by matching one-on-one the features of the same location in the continuous frame images by the portable terminal.

At step 705, the motion factor related to the movement of the walker may be determined using the optical flow of each feature by the portable terminal.

After the motion factor is determined, at step 707 the overall features of the subject may be separated and/or classified using the motion factor as the fixed features and the moving features by the portable terminal.

With continued reference to FIG. 7, at step 709, ROI that may become a preliminary group to the risk factor may be created by clustering the features of the moving subject and the features of the fixed subject in the portable terminal.

In the foregoing exemplary embodiment described hereinabove in detail, the motion factor related to the movement of the walker may be determined through the optical flow of each feature in the portable terminal. In this case, an error component occurring by the behavior pattern of the walker may be amended using a geometry sensor and a different component from the walking direction of the walker in the course of determination of the motion factor may be removed in the portable terminal.

As above-mentioned in detail, if the camera module 102 comprises at least one camera, ROI that may become a preliminary group to the risk factor may be created using two continuous frame images taken with one camera in the portable terminal.

If the camera comprises two or more cameras, ROI that may be become a preliminary group to the risk factor may be created as shown in FIG. 8.

The method performed according to FIG. 7 may be provided as one or more instructions in one or more software modules stored in the storage unit. In that case, the software modules may be executed by the controller 100.

FIG. 8 is a flowchart illustrating exemplary operation of a process for generating ROI in a portable terminal according to another exemplary embodiment of the present invention.

Referring now to FIG. 8, two frame images taken at the same time using the camera in step 301 illustrated in FIG. 3 may be obtained in the portable terminal. Then, at step 801 in FIG. 8, the corner features may be extracted in each frame image in the portable terminal.

After the corner features are extracted from each frame image, at step 803 a disparity map that matches one-on-one the features located at the identical location and shows the distance between each feature may be created by the portable terminal.

Next, at step 805, a depth map may be created by calculating depth using the disparity map in the step of 805 in the portable terminal. After the depth map is created, ROI may become a preliminary group to a risk factor by clustering images in which the depth is different from a peripheral area and features of a different area according to the depth map may be created in the step of 807 in the portable terminal.

The method performed according to FIG. 8 may be provided as one or more instructions in one or more software modules stored in the storage unit. In that case, the software modules may be executed by the controller 100.

In the above-mentioned exemplary embodiment, the ROI that can become a preliminary group to a risk factor may be created by assuming that one camera or two cameras are equipped in the portable terminal.

In another exemplary embodiment, if the camera module 102 of the portable terminal has an infrared camera, the ROI that may become a preliminary group to a risk factor may be created using two continuous frame images taken with the infrared camera as shown in FIG. 6 or FIG. 7.

In another exemplary embodiment, the ROI that may become a preliminary group to a risk factor may be created not by using a camera, but by utilizing a sound wave transmitting and receiving device. For example, if a sound wave transmitting and receiving module is installed in the portable terminal, a preliminary risk factor component located on a route of a walker may be detected considering the time difference of reception after reflected on a subject in the sound wave transmitting and receiving module. In this case, the method for extracting a risk factor on the walking route may be identical to that of the foregoing exemplary embodiments in which a preliminary risk factor component verified from the reflected signal may be matched to the risk factor data of the area where the portable terminal is located except for the gain process of ROI (from step 301 to 303, from step 407 to 409 and form step 503 to 505).

In still another exemplary embodiment, it may be verified only that a risk factor exists on the route of the walker using the sound wave transmitting and receiving device of the portable terminal.

As mentioned hereinabove, without a walking aid as in the presently claimed invention, a risk factor will be missed without such a walking aid device that provides a guiding service by the portable terminal when a blind person or visually impaired person walks about.

And also, power consumption may be reduced by providing a guiding service with adaptation according to the particular position of the blind person in the portable terminal.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitute hardware in the claimed invention.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A method for providing a guiding service in a portable terminal, the method comprising:
obtaining by a camera an image of a walker's route;
extracting by an image processor at least one preliminary risk factor component from the image by analyzing the image;
verifying that said at least one preliminary risk factor component constitutes a risk factor data depending on a position of the portable terminal within a predetermined distance of said at least one preliminary risk factor component on the walker's route; and
detecting whether there is a risk factor associated with the walker's route by comparing by a classifying unit the at least one preliminary risk factor component with said risk factor data.

2. The method of claim 1, wherein the step of extracting at least one preliminary risk factor component from the image comprises:
extracting features or contour line information from the image by the image processor using an extracted corner point and edge information; and
extracting said at least one preliminary risk factor component by clustering the features or the contour line information.

3. The method of claim 1, wherein the step of verifying a risk factor data comprises:
determining by a position determiner a position of the portable terminal; and
receiving a position factor data corresponding to the determined position of the portable terminal and a proximate distance to the preliminary risk factor component.

4. The method of claim 1, wherein the step of verifying a risk factor data comprises:
determining by a position determiner a position factor data of the portable terminal; and
extracting the position factor data corresponding to the position of the portable terminal stored in a storage unit.

5. The method of claim 1, wherein the step of detecting the risk factor comprises:
verifying whether or not an image matched to the preliminary risk factor component exists in the risk factor data; and
when an matched image exists in the preliminary risk factor component, detecting the matched image as a risk factor.

6. The method of claim 1, wherein the method further comprising:
estimating by a controller a degree of risk of a walker's route;
determining a check period depending on the degree of risk of the walker's route; and
obtaining an image of the route, when the check period of the risk factor arrives.

7. The method of claim 6, where the step of estimating a degree of degree comprises:
determining by a position determiner a positional information of the portable terminal; and
determining the degree of risk of the walker's route depending on the position of the portable terminal relative to detected risk factors.

8. The method of claim 6, wherein the step of estimating the degree of risk of a route of a walker comprising:
determining the degree of risk of the walker's route by determining peripheral sounds within a predetermined distance of the portable terminal.

9. The method of claim 1, wherein the method further comprises:
generating a warning event regarding the detected risk factor.

10. The method of claim 9, wherein the step of generating a warning event regarding the detected risk factor comprises:
outputting a warning message including at least information selected from a group consisting of the collision risk between the detected risk factor and the walker, the distance between the detected risk factor and the walker, and an estimated time for the walker to collide with the detected risk factor and the direction of the detected risk factor.

11. An apparatus for a guiding service in a portable terminal, the apparatus comprising:
a camera module for obtaining an image of a walker's route;
a position determiner for verifying a position of the portable terminal along a walker's route; and
a controller for extracting at least one preliminary risk factor component from the image obtained of the walker's route from the camera module and detecting a risk factor on the walker's route by matching the at least one preliminary risk factor component with risk factor data depending on the position of the portable terminal determined by the position determiner.

12. The apparatus of claim 11, wherein the controller comprises:
an image processor for extracting a preliminary risk factor component from the image of the walker's route obtained by the camera module;
a storage controller for verifying the risk factor data depending on the position of the portable terminal verified by the position determiner; and
a classifying unit for matching the at least one preliminary risk factor component with the risk factor data depending on the position of the portable terminal and detecting the risk factor on the walker's route.

13. The apparatus of claim 12, wherein the image processor extracts features or contour line information using extracted corner points and edge information in an image obtained from the camera module and extracts at least one preliminary risk factor component from the image by clustering the features or the contour line information.

14. The apparatus of claim 12, wherein the storage controller is provided with a position factor data from a server corresponding to the position of the portable terminal.

15. The apparatus of claim 12, wherein the storage controller extracts position factor data corresponding to the position of the portable terminal from a storage unit including position factor data related to at least one area of the walker's route.

16. The apparatus of claim 12, wherein the classifying unit detects s an image matched to the preliminary risk factor component from images included in the risk factor data as a risk factor.

17. The apparatus of claim 12, wherein the apparatus further comprising an information generator for generating a warning message including at least one information selected from a group consisting of the collision risk between the extracted risk factor and the walker, the distance between the risk factor and the walker, the estimated time taken for the walker to collide the risk factor and the direction of the risk factor.

18. The apparatus of claim 11, wherein the controller determines a check period of the risk factor according to a degree of risk of the walker's route and controls the camera module to obtain an image of the walker's route, if the check period of the risk factor arrives.

19. The apparatus of claim 18, wherein the controller determines the degree of risk of the walker's route by considering the position of the portable terminal or a peripheral sound sensed by the portable terminal.

20. The apparatus of claim 11, wherein the apparatus further comprises an audio processor for outputting a warning message regarding the determined risk factor.
